(19) United States
(12) Patent Application Publication
(10) Pub. No.: US 2020/0243946 A1
(43) Pub. Date: Jul. 30, 2020

(54) BRACKETS AND METHODS FOR ATTACHING ANTENNA TO POLES

(71) Applicants: Jan M. Goldfluss, Ridgefield, CT (US); Rodney Barnes, Groveland, FL (US); Lewis James Burrows, Fairfield, CA (US)

(72) Inventors: Jan M. Goldfluss, Ridgefield, CT (US); Rodney Barnes, Groveland, FL (US); Lewis James Burrows, Fairfield, CA (US)

(21) Appl. No.: 16/261,127

(22) Filed: Jan. 29, 2019

(51) Int. Cl. H01Q 1/24; H01Q 1/12

(52) U.S. Cl. CPC H01Q 1/241; H01Q 1/1207

(57) ABSTRACT

A bracket for attaching one or more antennas to a pole includes a curved mounting plate, an extension arm, and a shaft. The extension arm has a first end and a second end. The first end of the extension arm is attached to the curved mounting plate. The extension arm is attached to and extends from the curved mounting plate. The shaft is irremovably connected with or to a second end of the extension arm. The shaft extends longitudinally around a central shaft axis. A longitudinal axis of the extension arm is disposed perpendicularly to the central shaft axis

### FIELD OF THE DISCLOSURE

This disclosure relates to brackets and to methods for attaching antennas to poles extending out of the ground.

### BACKGROUND

Poles attached to the ground are often used to support antennas off the ground in urban and rural environments. These poles, typically owned by public utility companies and/or municipalities, are strictly regulated and demand conformance to specific mounting regulations. A variety of apparatus are used to attach the antennas to the poles. These apparatus typically are limited in how the antennas may be configured and/or positioned relative to the pole, and expose wiring to the antenna which is not aesthetically pleasing. Often such apparatus require extensive customized shop fabrication and timely installation on-site which increases cost. Other such apparatus may have additional issues.

An apparatus and method is needed to reduce or eliminate one or more of the issues associated with current apparatus and methods for attaching antennas to poles.

### SUMMARY

In one embodiment, a bracket is disclosed for attaching one or more antennas to a pole. The bracket includes a curved mounting plate, an extension arm, and a shaft. The extension arm has a first end and a second end. The first end of the extension arm is attached to the curved mounting plate. The extension arm is attached to and extends from the curved mounting plate. The shaft is irremovably connected with or to a second end of the extension arm. The shaft extends longitudinally around a central shaft axis. A longitudinal axis of the extension arm is disposed perpendicularly to the central shaft axis.

In another embodiment, a method of attaching an antenna to a pole is disclosed. In one step, a curved mounting plate of a bracket is attached to a pole. In another step, an antenna is attached with or to a shaft of the bracket. A first end of an extension arm of the bracket is attached to the curved mounting plate, a second end of the extension arm is irremovably connected with or to the shaft, and the shaft extends longitudinally around a central shaft axis which is perpendicular to a longitudinal axis of the extension arm.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 illustrates a perspective view of one embodiment of a pole having equipment and an antenna attached to the pole;

FIG. 2 illustrates a front perspective view within rectangle 2-2 of FIG. 1 showing a bracket attaching the antenna to the pole;

FIG. 3 illustrates the view of FIG. 2 with optional detachable extension shafts detached from a shaft of the bracket and the antenna removed;

FIG. 4 illustrates a rear perspective view of the view of FIG. 3;

FIG. 5 illustrates a front perspective view of another embodiment of a bracket attaching antennas to a pole;

FIG. 6 illustrates the view of FIG. 5 with optional detachable extension shafts detached from shafts of the bracket and the antennas removed;

FIG. 7 illustrates a rear perspective view of the view of FIG. 5;

FIG. 8 illustrates a front perspective view of another embodiment of a bracket attaching antennas to a pole;

FIG. 9 illustrates the view of FIG. 8 with optional detachable extension shafts detached from shafts of the bracket and the antennas removed;

FIG. 10 illustrates a rear perspective view of the view of FIG. 8; and

FIG. 11 illustrates one embodiment of a method of attaching an antenna to a pole.

### DETAILED DESCRIPTION

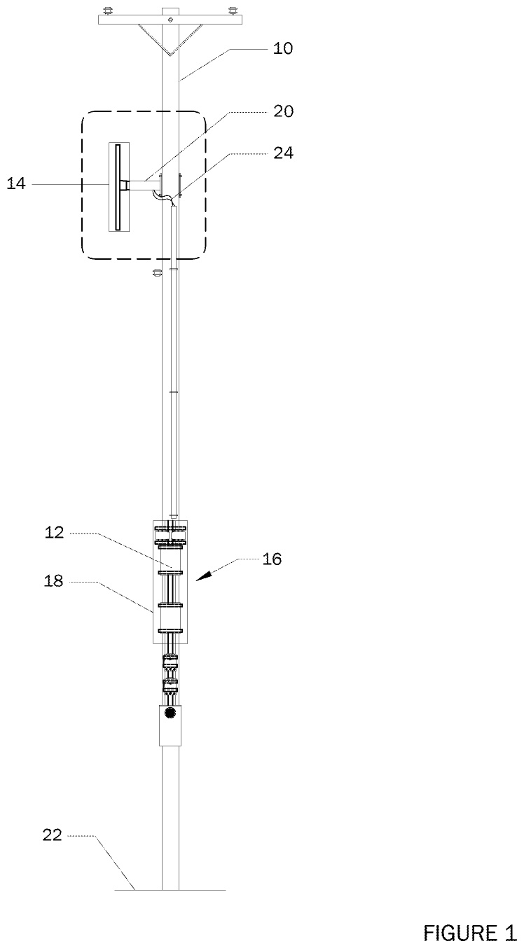

FIG. 1 illustrates a perspective view of one embodiment of a pole 10 having equipment 12 and an antenna 14 attached to the pole 10. An apparatus 16 attaches the equipment 12, within a shroud 18 of the apparatus 16, to the pole 10. A bracket 20 attaches the antenna 14 to the pole 10. The pole 10 may comprise a wood pole which may be attached to the ground 22 in an urban or rural environment. The equipment 12 may comprise equipment powering and/or connected to the antenna 14. The equipment 12 is wired to the antenna 14 using wiring 24. The antenna 14 may send out a wireless signal which can be received by cell-phones and other communication equipment.

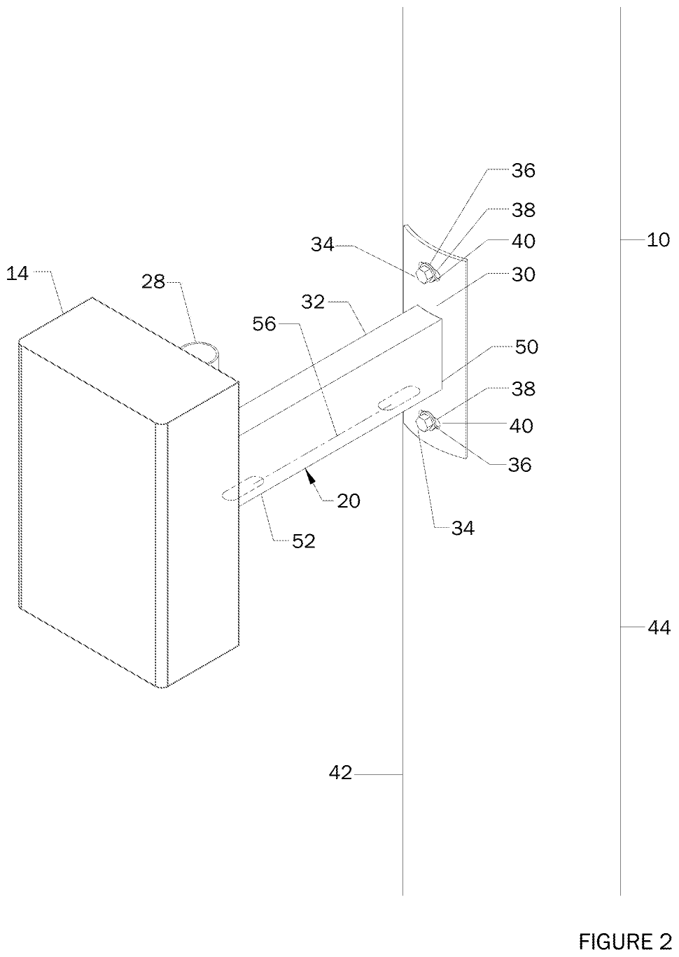

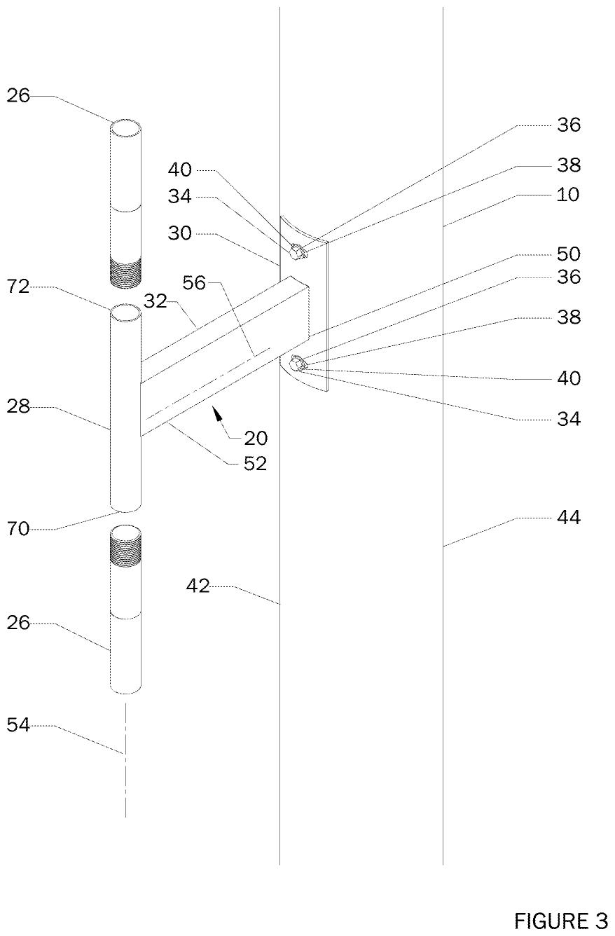

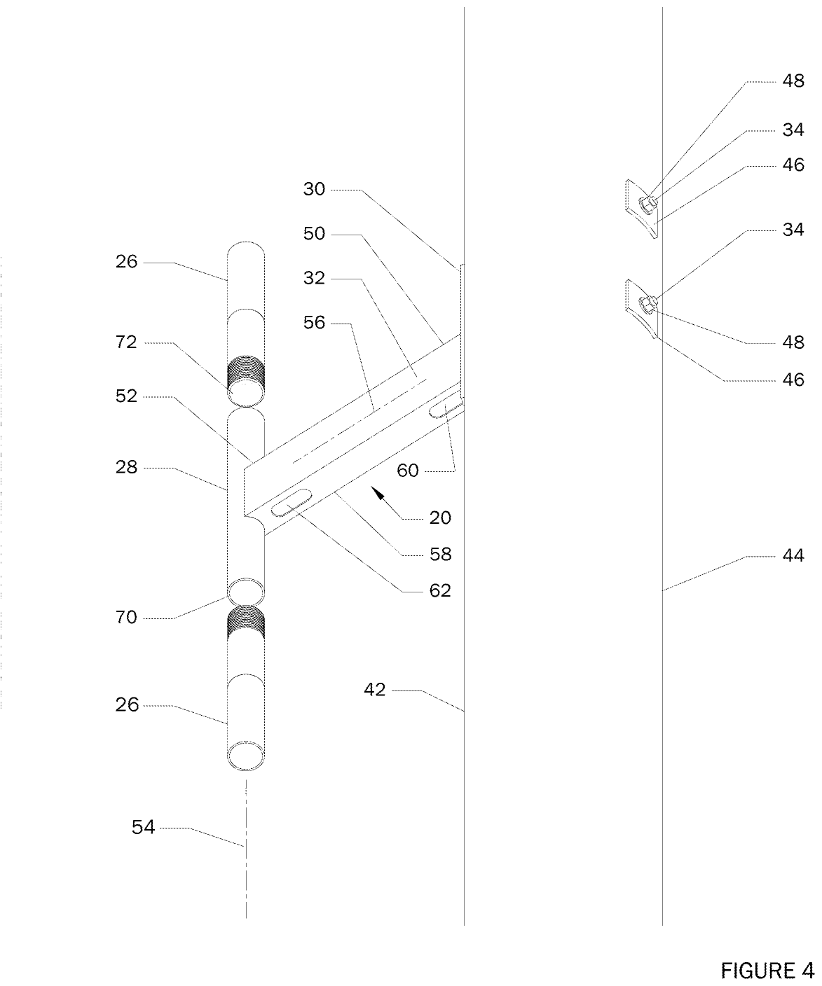

FIG. 2 illustrates a front perspective view within rectangle 2-2 of FIG. 1 showing the bracket 20 attaching the antenna 14 to the pole 10. FIG. 3 illustrates the view of FIG. 2 with optional detachable extension shafts 26 detached from a shaft 28 of the bracket 20 and the antenna 14 removed. FIG. 4 illustrates a rear perspective view of the view of FIG. 3.

As shown in FIGS. 1-4 collectively, the bracket 20 comprises a curved mounting plate 30, an extension arm 32, and shaft 28. The bracket 20 is attached to the pole using fastening devices 34. The fastening devices 34 may comprise bolts. The fastening devices 34 extend through washers 36, through holes 38 in the curved mounting plate 30, through drilled holes 40 in one side 42 of the pole 10, out of the drilled holes 40 on a second side 44 of the pole 10, through curved washers 46, and are threadedly attached to nuts 48.

The extension arm 32 may be linear. The extension arm 32 comprises a first end 50 and a second end 52. The first end 50 of the extension arm 32 is irremovably attached (such as through welding or another irremovable attachment method) to the curved mounting plate 30 with the extension arm 32 extending from the curved mounting plate 30. The shaft 28 is irremovably (such as through welding or another irremovable attachment method) connected to the second end 52 of the extension arm 32. The shaft 28 extends longitudinally around a central shaft axis 54. A longitudinal axis 56 of the extension arm 32 is disposed perpendicularly to the central shaft axis 54. An interior of the extension arm 32 is hollow. An underside surface 58 of the extension arm 32 comprises holes 60 and 62 connected to the hollow interior of the extension arm 32. The hole 60 is disposed adjacent to the first end 50 of the extension arm 32 and the hole 62 is disposed adjacent to the second end 52 of the extension arm 32. Wiring connected to the antenna 14 may be extended from the antenna 14, through the second hole 62 of the extension arm 32, through the hollow interior of the extension arm 32, out of the hole 60 of the extension arm 32, and down the pole 10 to the equipment.

The optional detachable extension shafts 26 may be threadedly attached to any of opposed ends 70 and 72 of the shaft 28. In other embodiments, the optional detachable extension shafts 26 may be attached to any of the opposed ends 70 and 72 of the shaft 28 using varying attachment methods. The antenna 14 may be clamped to the shaft 28 or to one or more of the optional detachable extension shafts 26 in varying configurations. The optional detachable extension shafts 26 allow for one or more antenna 14 to be attached to the bracket 20 in varying positions and configurations relative to the pole 10. In other embodiments, the bracket 20 of FIGS. 1-4 may vary.

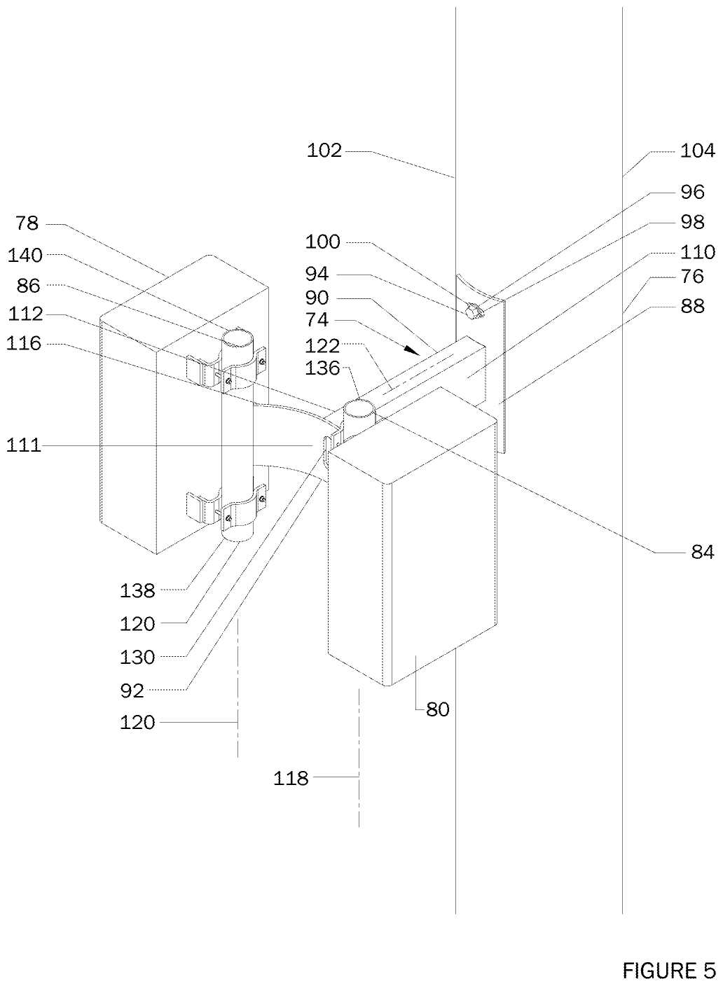

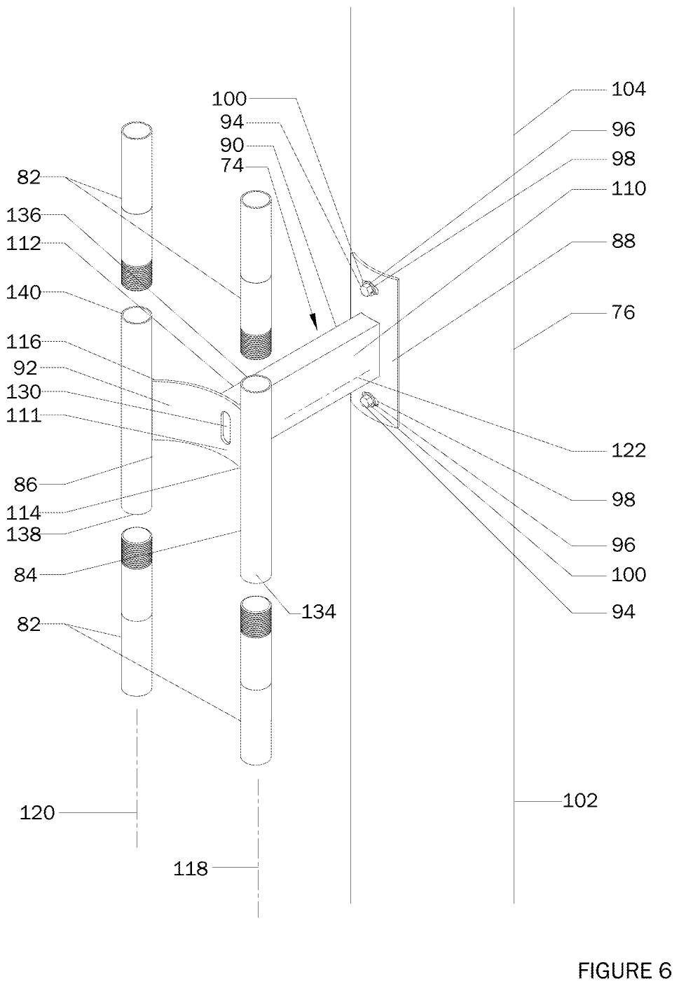

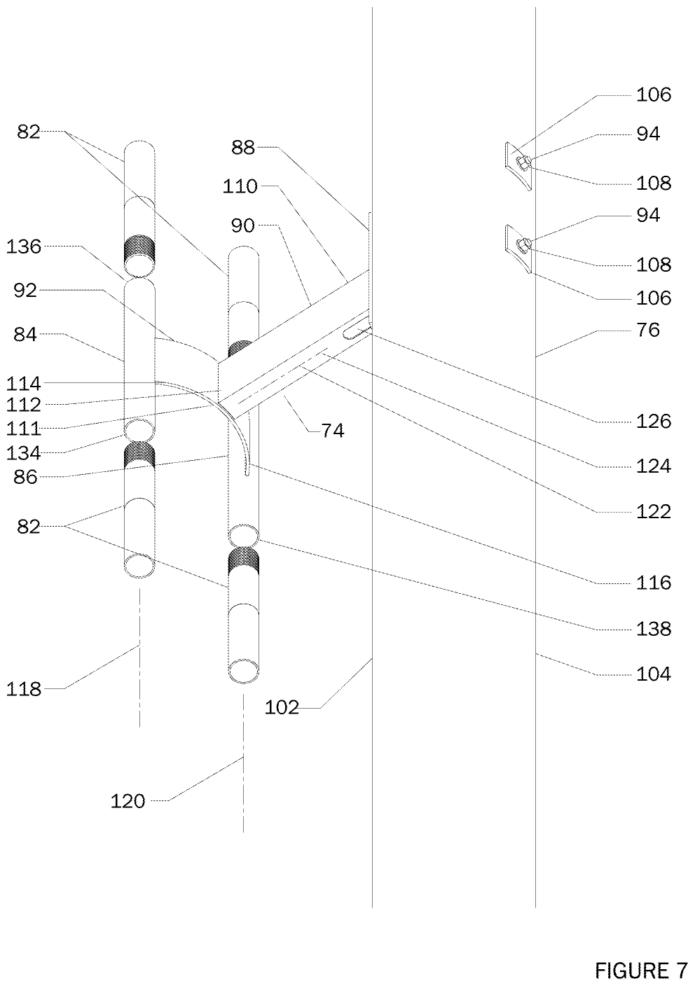

FIG. 5 illustrates a front perspective view of another embodiment of a bracket 74 attaching antennas 78 and 80 to a pole 76. FIG. 6 illustrates the view of FIG. 5 with optional detachable extension shafts 82 detached from shafts 84 and 86 of the bracket 74 and the antennas 78 and 80 removed. FIG. 7 illustrates a rear perspective view of the view of FIG. 5.

As shown in FIGS. 5-7 collectively, the bracket 74 comprises a curved mounting plate 88, an extension arm 90, a curved extension arm 92, and shafts 84 and 86. The bracket 74 is attached to the pole 76 using fastening devices 94. The fastening devices 94 may comprise bolts. The fastening devices 94 extend through washers 96, through holes 98 in the curved mounting plate 88, through drilled holes 100 in one side 102 of the pole 76, out of the drilled holes 100 on a second side 104 of the pole 76, through curved washers 106, and are threadedly attached to nuts 108.

The extension arm 90 may be linear while the curved extension arm 92 is curved. In other embodiments, the extension arms 90 and 92 may be in varying linear or curved shapes. The extension arm 90 comprises a first end 110 and a second end 112. The first end 110 of the extension arm 90 is irremovably attached (such as through welding or another irremovable attachment method) to the curved mounting plate 88 with the extension arm 90 extending from the curved mounting plate 88. A middle area 111 of the curved extension arm 92 is irremovably attached (such as through welding or another irremovable attachment method) to the second end 112 of the extension arm 90. Shafts 84 and 86 are irremovably attached (such as through welding or another irremovable attachment method), in parallel alignment to one another, to opposed ends 114 and 116 of the curved extension arm 92. The shafts 84 and 86 extend longitudinally around respective central shaft axis 118 and 120. A longitudinal axis 122 of the extension arm 90 is disposed perpendicularly to the central shaft axis 118 and 120. An interior of the extension arm 90 is hollow. An underside surface 124 of the extension arm 90 comprises a hole 126, and an end surface of the second end 112 of the extension arm 90 comprises a hole 130. The first and second holes 126 and 130 are connected to the hollow interior of the extension arm 90. The hole 126 is disposed adjacent to the first end 110 of the extension arm 90 and the hole 130 is disposed adjacent to the second end 112 of the extension arm 90. Wiring connected to the antennas 78 and 80 may be extended from the antennas 78 and 80, through the hole 130 of the extension arm 90, through the hollow interior of the extension arm 90, out of the hole 126 of the extension arm 90, and down the pole 76 to equipment.

The optional detachable extension shafts 82 may be threadedly attached to any of opposed ends 134 and 136 of shaft 84 and/or to opposed ends 138 and 140 of shaft 86. In other embodiments, the optional detachable extension shafts 82 may be attached to any of the opposed ends 134 and 136 of shaft 84 and/or to the opposed ends 138 and 140 of shaft 86 using varying attachment methods. The antennas 78 and 80 may be clamped to the shafts 84 or 86 or to one or more of the optional detachable extension shafts 82 in varying configurations. The optional detachable extension shafts 82 allow any number of antenna 78 and 80 to be attached to the bracket 74 in varying positions and configurations relative to the pole 76. In other embodiments, the bracket 74 of FIGS. 5-7 may vary.

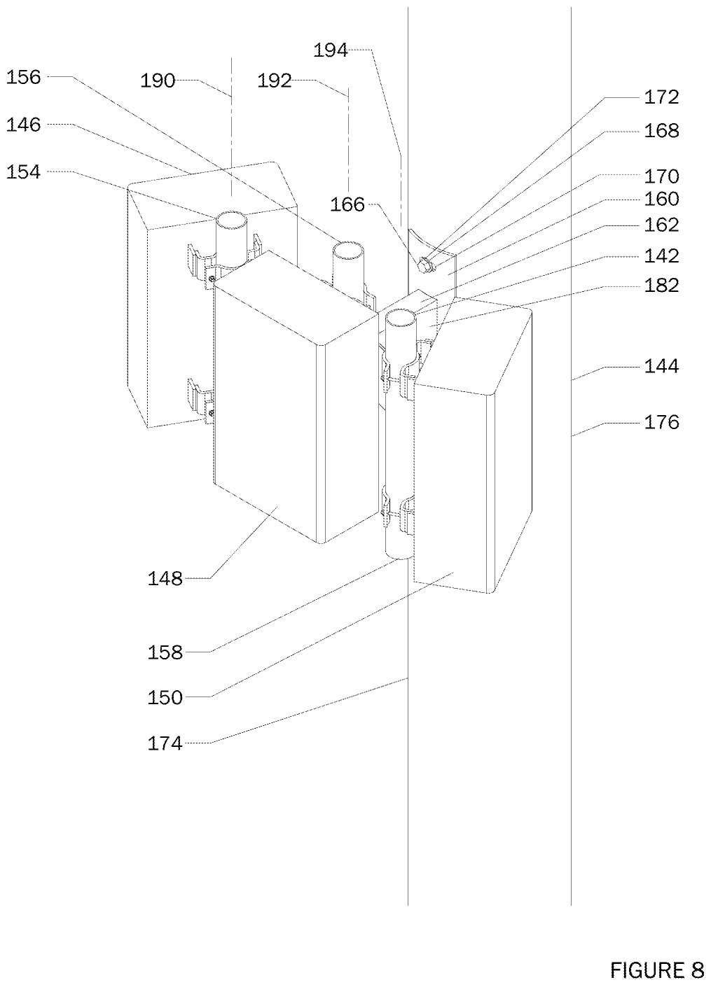

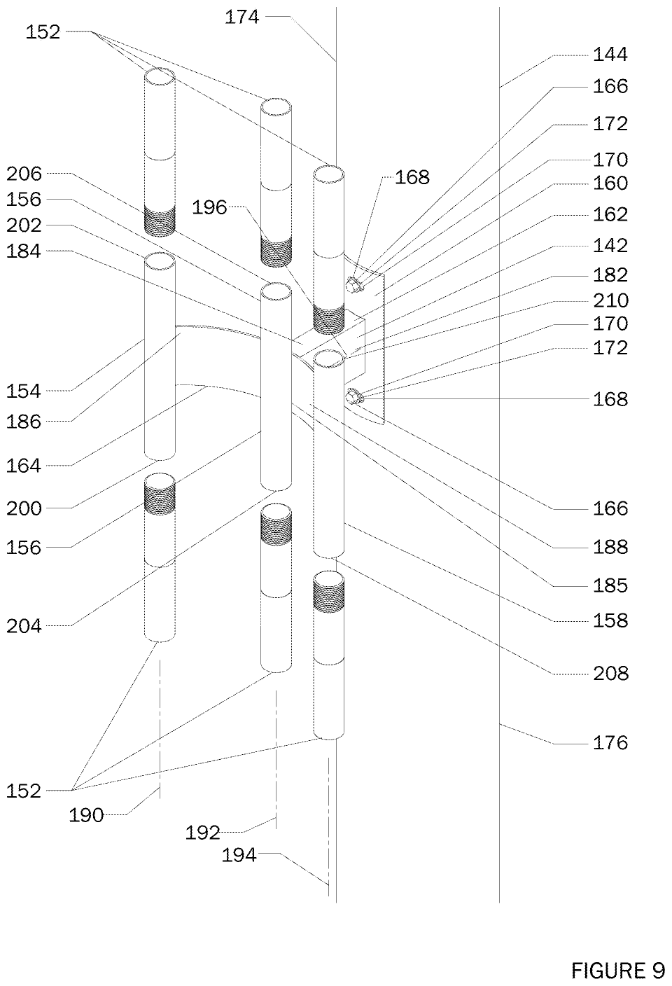

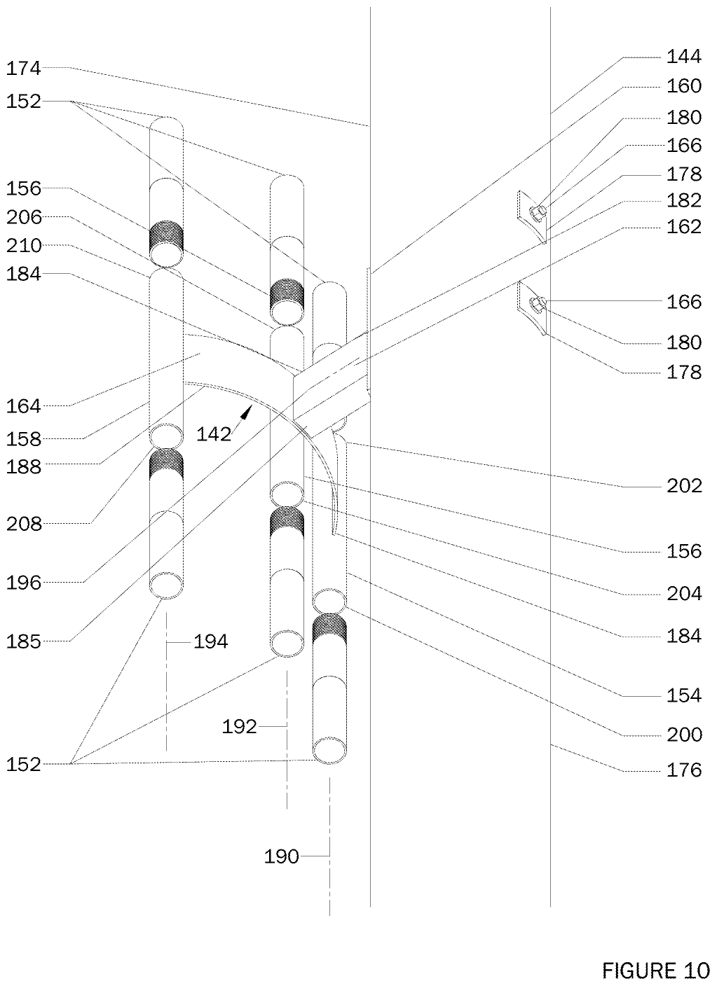

FIG. 8 illustrates a front perspective view of another embodiment of a bracket 142 attaching antennas 146, 148, and 150 to a pole 144. FIG. 9 illustrates the view of FIG. 8 with optional detachable extension shafts 152 detached from shafts 154, 156, and 158 of the bracket 142 and the antennas 146, 148, and 150 removed. FIG. 10 illustrates a rear perspective view of the view of FIG. 8.

As shown in FIGS. 8-10 collectively, the bracket 142 comprises a curved mounting plate 160, an extension arm 162, a curved extension arm 164, and shafts 154, 156, and 158. The bracket 142 is attached to the pole 144 using fastening devices 166. The fastening devices 166 may comprise bolts. The fastening devices 166 extend through washers 168, through holes 170 in the curved mounting plate 160, through drilled holes 172 in one side 174 of the pole 144, out of the drilled holes 172 on a second side 176 of the pole 144, through curved washer plates 178, and are threadedly attached to nuts 180.

The extension arm 162 may be linear while the curved extension arm 164 is curved. In other embodiments, the extension arms 162 and 164 may be in varying linear or curved shapes. The extension arm 162 comprises a first end 182 and a second end 184. The first end 182 of the extension arm 162 is irremovably attached (such as through welding or another irremovable attachment method) to the curved mounting plate 160 with the extension arm 162 extending from the curved mounting plate 160. A middle area 185 of the curved extension arm 164 is irremovably attached (such as through welding or another irremovable attachment method) to the second end 184 of the extension arm 162. Shafts 154 and 158 are irremovably attached (such as through welding or another irremovable attachment method), in parallel alignment to one another, to opposed ends 186 and 188 of the curved extension arm 164. Shaft 156 is irremovably attached (such as through welding or another irremovable attachment method) to the middle area 185 of the curved extension arm 164, in between the opposed ends 186 and 188 of the curved extension arm 164, in parallel alignment to shafts 154 and 156. The shafts 154, 156, and 158 extend longitudinally around respective central shaft axis 190, 192, and 194. A longitudinal axis 196 of the extension arm 162 is disposed perpendicularly to the central shaft axis 190, 192, and 194. Wiring connected to the antennas 146, 148, and 150 may be extended from the antennas 146, 148, and 150 and down the pole 144 to equipment.

The optional detachable extension shafts 152 may be threadedly attached to any of opposed ends 200 and 202 of shaft 154, to opposed ends 204 and 206 of shaft 156, and/or to opposed ends 208 and 210 of shaft 158. In other embodiments, the optional detachable extension shafts 152 may be attached to any of the opposed ends 200 and 202 of shaft 154, to the opposed ends 204 and 206 of shaft 156, and/or to the opposed ends 208 and 210 of shaft 158 using varying attachment methods. The antennas 146, 148, and 150 may be clamped to the shafts 154, 156, or 158 or to one or more of the optional detachable extension shafts 152 in varying configurations. The optional detachable extension shafts 152 allow any number of antenna 146, 148, and 150 to be attached to the bracket 142 in varying positions and configurations relative to the pole 144. In other embodiments, the bracket 142 of FIGS. 8-10 may vary.

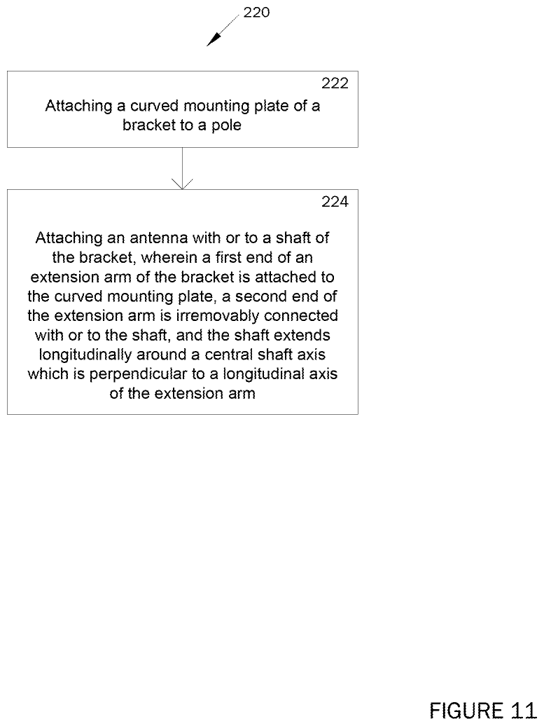

FIG. 11 illustrates one embodiment of a method 220 of attaching an antenna to a pole. The method 220 may utilize any of the brackets disclosed herein. In other embodiments, the method 220 may utilize varying brackets. Step 222 comprises attaching a curved mounting plate of a bracket to a pole. Step 224 comprises attaching an antenna with or to a shaft of the bracket, wherein a first end of an extension arm of the bracket is attached to the curved mounting plate, a second end of the extension arm is irremovably connected with or to the shaft, and the shaft extends longitudinally around a central shaft axis which is perpendicular to a longitudinal axis of the extension arm.

In one embodiment of the method 220, the second end of the extension arm may be irremovably connected to the shaft. An optional step may comprise extending a wire from the antenna through a first hole, adjacent the first end, in an underside of the extension arm, through an interior of the extension arm, and out of a second hole, adjacent the second end, in the extension arm. Another optional step may comprise attaching a detachable extension arm to the shaft or to opposed ends of the shaft. The attaching may comprise threadedly attaching or other types of attaching methods. Still another optional step may comprise attaching the antenna to the detachable extension arm.

In another embodiment of the method 220, a curved extension arm of the bracket is irremovably attached to the second end of the extension arm, and the shaft and a second shaft are attached to opposed ends of the curved extension arm with the second shaft disposed parallel to the shaft. An optional step may comprise extending a wire from the antenna, through a second hole in an end surface of the second arm of the extension arm, through an interior of the extension arm, and out of a first hole in an underside surface of the extension arm. Another optional step comprises attaching a first antenna to the shaft, and attaching a second antenna to the second shaft. Still another optional step comprises attaching at least one detachable extension shaft to at least one of the shaft and the second shaft. The attaching may comprise threadedly attaching or another attachment method. Still another optional step may comprise attaching the antenna to the at least one detachable extension arm.

In another embodiment of the method 220, a curved extension arm of the bracket is irremovably attached to the second end of the extension arm, the shaft and a second shaft are attached to opposed ends of the curved extension arm, a third shaft is attached to a middle area, in between the opposed ends, of the curved extension arm, and the second and third shafts are disposed parallel to the shaft. An optional step may comprise attaching a first antenna to the shaft, attaching a second antenna to the second shaft, and attaching a third antenna to the third shaft. Still another optional step may comprise attaching at least one detachable extension shaft to at least one of the shaft, the second shaft, and the third shaft. The attaching may comprise threadedly attaching or another attachment method. Still another optional step may comprise attaching the antenna to the at least one detachable extension arm.

In other embodiments, one or more steps of the method 220 may be modified in substance and/or in order, one or more steps of the method 220 may not be followed, or one or more additional steps may be added.

One or more embodiments of the disclosure may have one or more of the following advantages: quick and easy configurability of the number and location of antennas attached by a bracket to a pole; concealment of wiring connected to antenna attached by a bracket to a pole; and/or to the reduction or elimination of one or more other issues.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. Furthermore, it is to be understood that the disclosure is defined by the appended claims. Accordingly, the disclosure is not to be restricted except in light of the appended claims and their equivalents.

1. A bracket for attaching one or more antennas to a pole, the bracket comprising:
a curved mounting plate;
an extension arm having a first end and a second end, the first end of the extension arm attached to the curved mounting plate, the extension arm attached to and extending from the curved mounting plate; and
a shaft irremovably connected with or to a second end of the extension arm, the shaft extending longitudinally around a central shaft axis, a longitudinal axis of the extension arm disposed perpendicularly to the central shaft axis.

2. The bracket of claim 1 wherein the shaft is irremovably connected to a second end of the extension arm.

3. The bracket of claim 1 wherein an interior of the extension arm is hollow, and an underside surface of the extension arm comprises first and second holes, the first hole disposed adjacent the first end of the extension arm and the second hole disposed adjacent the second end of the extension arm.

4. The bracket of claim 1 further comprising detachable extension shafts attached to opposed ends of the shaft.

5. The bracket of claim 4 wherein the detachable extension shafts are threadedly attached to the opposed ends of the shaft.

6. The bracket of claim 2 wherein the bracket is attached to the pole, and one antenna is attached to the shaft.

7. The bracket of claim 1 further comprising a curved extension arm attached to the second end of the extension arm.

8. The bracket of claim 7 wherein the curved extension arm is irremovably attached to the second end of the extension arm.

9. The bracket of claim 7 wherein the shaft and a second shaft are attached to opposed ends of the curved extension arm, the second shaft disposed parallel to the shaft.

10. The bracket of claim 8 wherein the shaft and the second shaft are irremovably attached to the opposed ends of the curved extension arm.

11. The bracket of claim 7 wherein an interior of the extension arm is hollow, an underside surface of the extension arm comprises a first hole, and an end surface of the second end of the extension arm comprises a second hole.

12. The bracket of claim 9 further comprising detachable extension shafts attached to opposed ends of each of the shaft and the second shaft.

13. The bracket of claim 12 wherein the detachable extension shafts are threadedly attached to the opposed ends of each of the shaft and the second shaft.

14. The bracket of claim 9 wherein the bracket is attached to the pole, a first antenna is attached to the shaft, and a second antenna is attached to the second shaft.

15. The bracket of claim 7 wherein the shaft and a second shaft are attached to opposed ends of the curved extension arm, a third shaft is attached to a middle area, in between the opposed ends, of the curved extension arm, and the second and third shafts are disposed parallel to the shaft.

16. The bracket of claim 15 wherein the shaft and the second shaft are irremovably attached to the opposed ends of the curved extension arm, and the third shaft is irremovably attached to the middle area of the curved extension arm.

17. The bracket of claim 15 further comprising detachable extension shafts attached to opposed ends of each of the shaft, the second shaft, and the third shaft.

18. The bracket of claim 17 wherein the detachable extension shafts are threadedly attached to the opposed ends of each of the shaft, the second shaft, and the third shaft.

19. The bracket of claim 15 wherein the bracket is attached to the pole, a first antenna is attached to the shaft, a second antenna is attached to the second shaft, and a third antenna is attached to the third shaft.

20. A method of attaching an antenna to a pole comprising:
attaching a curved mounting plate of a bracket to a pole; and
attaching an antenna with or to a shaft of the bracket, wherein a first end of an extension arm of the bracket is attached to the curved mounting plate, a second end of the extension arm is irremovably connected with or to the shaft, and the shaft extends longitudinally around a central shaft axis which is perpendicular to a longitudinal axis of the extension arm.

21. The method of claim 20 wherein the second end of the extension arm is irremovably connected to the shaft.

22. The method of claim 21 further comprising extending a wire from the antenna through a first hole, adjacent the first end, in an underside surface of the extension arm, through an interior of the extension arm, and out of a second hole, adjacent the second end, in the extension arm.

23. The method of claim 21 further comprising attaching a detachable extension shaft to the shaft.

24. The method of claim 21 further comprising attaching detachable extension shafts to opposed ends of the shaft.

25. The method of claim 23 wherein the attaching comprises threadedly attaching.

26. The method of claim 23 wherein the attaching the antenna comprises attaching the antenna to the detachable extension shaft.

27. The method of claim 21 wherein a curved extension arm of the bracket is irremovably attached to the second end of the extension arm, and the shaft and a second shaft are attached to opposed ends of the curved extension arm, the second shaft disposed parallel to the shaft.

28. The method of claim 27 further comprising extending a wire from the antenna, through a second hole in an end surface of the second end of the extension arm, through an interior of the extension arm, and out of a first hole in an underside surface of the extension arm.

29. The method of claim 27 wherein the attaching the antenna comprises attaching a first antenna to the shaft, and attaching a second antenna to the second shaft.

30. The method of claim 27 further comprising attaching at least one detachable extension shaft to at least one of the shaft and the second shaft.

31. The method of claim 30 wherein the attaching comprises threadedly attaching.

32. The method of claim 30 wherein the attaching the antenna comprises attaching the antenna to the at least one detachable extension shaft.

33. The method of claim 21 wherein a curved extension arm of the bracket is irremovably attached to the second end of the extension arm, the shaft and a second shaft are attached to opposed ends of the curved extension arm, a third shaft is attached to a middle area, in between the opposed ends, of the curved extension arm, and the second and third shafts are disposed parallel to the shaft.

34. The method of claim 33 wherein the attaching the antenna comprises attaching a first antenna to the shaft, attaching a second antenna to the second shaft, and attaching a third antenna to the third shaft.

35. The method of claim 33 further comprising attaching at least one detachable extension shaft to at least one of the shaft, the second shaft, and the third shaft.

36. The method of claim 35 wherein the attaching comprises threadedly attaching.

37. The method of claim 35 wherein the attaching the antenna comprises attaching the antenna to the at least one detachable extension shaft.
